(19) United States
(12) Patent Application Publication
(10) Pub. No.: US 2009/0252595 A1
(43) Pub. Date: Oct. 8, 2009

(54) NON-CONTACTING FACE SEALS AND THRUST BEARINGS

(75) Inventors: Edward Henry Cross, Bath (GB); Rodney Alan Cross, Bath (GB)

Correspondence Address: VOLENTINE & WHITT PLLC, ONE FREEDOM SQUARE, 11951 FREEDOM DRIVE SUITE 1260, RESTON, VA, 20190, US

(73) Assignee: CROSS MANUFACTURING CO. )1983) LTD., Bath (GB)

(21) Appl. No.: 12/410,800

(22) Filed: Mar. 25, 2009

Related U.S. Application Data
(60) Provisional application No. 61/042,795, filed on Apr. 7, 2008.

(51) Int. Cl. F04D 29/057; F16C 17/04; F16C 27/08; F01D 25/16; F04D 29/10

(52) U.S. Cl. 415/111; 415/107

(57) ABSTRACT

Apparatus is for spacing two relatively rotatable facing surfaces in use by entraining gas between the surfaces. The apparatus includes a first portion defining a generally frusto-conical surface, a second portion including at least one flat surface disposed on a carrier, the flat surface being located adjacent the first portion so that the generally frusto-conical surface and the flat surface face each other and define at least one point of closest engagement between the surfaces, with diverging gaps extending between the surfaces on either side of a plane which contains the point or points of closest engagement and which extends generally orthogonal to the direction of relative rotation, and a device for biasing the flat surface towards the frusto-conical surface to maintain a gap between the surfaces within a predetermined dimensional range. The carrier includes a plurality of portions releasably connected together.

### BACKGROUND

The present invention relates to non-contacting face seals and thrust bearings.

WO-A-2005/015064 (the contents of which are hereby incorporated by reference) in the name of Cross Manufacturing Company (1938) Limited discloses an arrangement that can be used as a non-contacting face seal or thrust bearing. An axial thrust on a rotating member is generated by entraining a pressured gas film between static and rotating surfaces, the pressure being self-generated by the action of the relative gas velocity between the surfaces. The axial forces generated in this way may be used to control the gap in an associated face seal, or may act as a thrust bearing to balance the external axial forces which may exist on a shaft assembly.

Such an assembly can be an inter-stage gas seal that is required on large axial compressors and turbines where the gases being compressed/expanded have to be isolated from the inner cylindrical areas of the engine. An example of such a seal is shown in FIG. 10 of WO-A-2005/015064. In that example the face-sealing surfaces are designated 48 and 49 and the gap between them is controlled by the outer ring of tile elements and springs acting on the rotating member (which are described and illustrated in other parts of the reference, including FIGS. 1, 2 and 3). The tiles 2 are mounted on a non-rotating, but axially moveable tile carrier 44 and the self-generated forces are controlled by the coil or wave springs 4. It has been found that when it is necessary to examine or replace the wearing components of the seal the only way of dismantling it is to remove all the shaft mounted engine components from one or the other side of the seal assembly because in most engine applications the seal assembly is located between components that are of larger diameter than the seal assembly's smallest diameter. In practice, the parts of the seal which are most likely to need examination and possible replacement are the tiles, the spring or springs that bias the tiles towards the rotating member and the tile carrier.

### SUMMARY

Embodiments of the present invention provide a tile carrier that is formed of two separate portions/halves that are fixed together over the cylindrical surfaces which located the tile carrier, but allows the required axial movement after assembly. In such embodiments the tile carrier split line can coincide with a diameter passing between adjacent tile pivots, except that a small register may be included in the form of a step in the mating halves that accurately locates the two halves when they are bolted together.

According to one aspect of the present invention there is provided apparatus for spacing two relatively rotatable facing surfaces in use by entraining gas between the surfaces, the apparatus including:

a first portion defining a generally frusto-conical surface;

a second portion including at least one flat surface disposed on a carrier, the flat surface being located adjacent the first portion so that the generally frusto-conical surface and the flat surface face each other and define at least one point of closest engagement between the surfaces, with diverging gaps extending between the surfaces on either side of a plane which contains the point or points of closest engagement and which extends generally orthoginal to the direction of relative rotation, and

a device for biasing the flat surface towards the frusto-conical surface to maintain a gap between the surfaces within a predetermined dimensional range,

wherein the carrier comprises a plurality of portions releasably connected together.

In use, the carrier portions may form a continuous sliding cylindrical surface that corresponds to a cylindrical surface on the first portion. A pair of said carrier portions may be releasably connected together along a notional radial line extending from a centre of the cylinder.

The carrier portions may be connected together by means of a bolt arrangement. Alternatively, the carrier portions can be connected together by means of a bridge member that spans the carrier portions, a first part of the bridge member being releasably connected to one of the carrier members and another part of the bridge member being releasably connected to another one of the carrier members. Surfaces of the bridge member and corresponding surfaces of the carrier portions can include cooperating formations. The bridge member may be connected to each of the carrier portions by means of respective bolt arrangements such that, in use, tightening of the bolt arrangements reinforces engagement of the cooperating formations on the bridge member surfaces and the carrier portion surfaces.

The carrier portions can include inter-engaging formations. The inter-engaging formation on one of the carrier portions can includes a step and the inter-engaging formation on the other said carrier portion can include a corresponding recess. Alternatively, the inter-engaging formations can comprise dowels.

The apparatus may include a withdrawal space for allowing the carrier and a rotating member to be moved axially by a sufficient distance in order to disengage the cylindrical sealing surface during an access operation.

According to another aspect of the present invention there is provided an axially moveable tile carrier defining a radial sealing surface for forming, with a further radial sealing surface, a radial seal to separate internal and external pressure areas and an axially sealing surface cooperating with an axially slidable seal to separate the internal and external pressure areas whereby the radial location of the seal is selected such that the pressure applied by the internal and external pressure areas to the radial sealing surface is substantially balanced by at least the internal and external pressures applied to respective pressure-balancing surfaces opposing the radial sealing surface and wherein the carrier comprises a plurality of portions releasably connected together.

Although the invention has been defined above it must be understood that it includes any inventive combination of the features set out above or in the following description.

### BRIEF DESCRIPTION OF THE DRAWINGS

The invention may be performed in various ways and specific embodiments will now be described by way of example, with reference to the accompanying drawings in which:

FIG. 1 displays a section taken on two diameteral planes in an example arrangement in order to show, on the lower half of the drawing, a section on the split line and, on the upper half, a diameteral plane displaced angularly to pass through the pivot centre line of one of the adjacent tiles (these planes are designated XX in FIG. 2);

FIG. 2 shows a cross section of the tile carrier with two adjacent tiles in position, the section being taken on a plane passing through one of the tile carrier retaining bolts (this plane is designated YY in FIG. 1), and

FIG. 3 is a similar view to that of FIG. 2, illustrating an alternative embodiment of the tile carrier.

### DETAILED DESCRIPTION

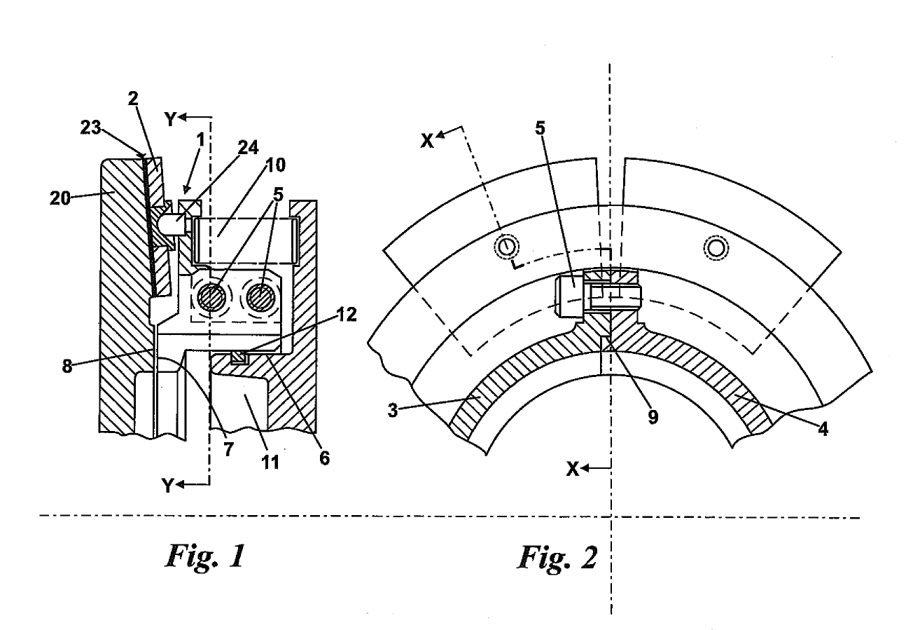

FIGS. 1 and 2 show a rotating member 20 having a frusto-conical surface 23. The general arrangement is similar to that of FIG. 10 of WO-A-2005/015064 as discussed above.

The tile carrier assembly 1 consists of a plurality of arc-shaped members and the outer ring of tiles 2 which are freely pivoted on a spherical sealed pivot or fulcrum 24. In the illustrated embodiment there are two semi-circular members 3 and 4. The two semi-circular members are held together by four bolts 5, the upper two of which are illustrated. The two semi-circular members, when bolted together, form a continuous sliding cylindrical surface on the cylindrical surface of the member 6 and a continuous sealing surface 7 which, in use, is held in close proximity to the matching rotating surface B. Use of releasable connecting means such as bolts allows the two members 3, 4 to be conveniently disconnected when desired, e.g. during maintenance.

In order to accurately position the two semi-circular members onto each other, a close fitting register in the form of a step 9 may be provided on one of the members 3 which cooperates with a recess provided on the other member 4. It will be appreciated that the step/recess shown is exemplary only and variations are possible. It will also be appreciated that other forms of accurately locating the two semi-circular members, such as dowels, may be used instead of the step/recess arrangement. A final machining operation may be required after the two members 3, 4 are bolted together to ensure an accurate connection.

In the design as illustrated in FIG. 1, where the seal is required to separate only two gas spaces 10 and 11 by the action of the face sealing surfaces 7 and 8 and the sealing ring 12, the removal of the tile carrier assembly is achieved by simply unscrewing the four retaining bolts 5. However, should it be required to provide a removable split tile carrier assembly for a seal designed to separate three or more gas spaces (such as illustrated in FIG. 12 of WO-A-2005/01504 A1) then a similar design of split tile carrier may be employed to that already described except that a withdrawal space is first created between the engine components so that the tile carrier assembly, together with the rotating member, can be moved axially by a sufficient distance in order to disengage the outer cylindrical sealing members (designated 52, 53 and 54 in the said FIG. 12).

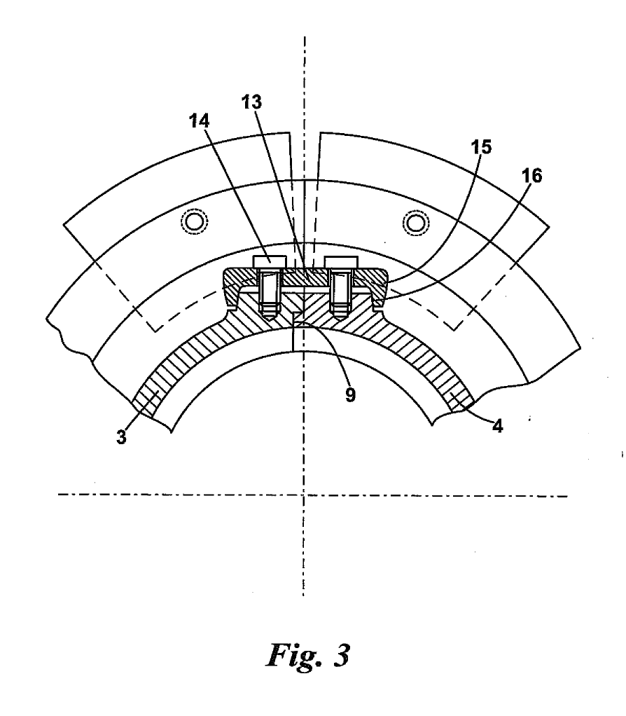

FIG. 3 shows an alternative way of locking the two semi-circular members 3, 4 together that may be especially suitable if the inner gas space 11 is at considerably higher pressure than the outer gas space 10, which would result in high stress and strain on the bolts 5 in the embodiment shown in FIGS. 1 and 2. The releasable locking mechanism in FIG. 3 comprises two diametrically-opposite bridge members 13 (one of which is shown in the Figure) that are held in position by bolts 14. Clamping members 15 at each bridge are slightly tapered on cooperating surfaces 16 of the carriers such that as the bolts 14 are tightened, these surfaces produce high compressive forces acting on the split line that are sufficient to contain the parting forces produced by the high differential gas pressure The skilled person will also appreciate that further alternatives, such as worm-drive hose clips, can be used to hold the carrier members together.

What is claimed is:

1. Apparatus for spacing two relatively rotatable facing surfaces in use by entraining gas between the surfaces, the apparatus comprising:
a first portion defining a generally frusto-conical surface;
a second portion including at least one flat surface disposed on a carrier, the flat surface being located adjacent the first portion so that the generally frusto-conical surface and the flat surface face each other and define at least one point of closest engagement between the surfaces, with diverging gaps extending between the surfaces on either side of a plane which contains the point or points of closest engagement and which extends generally orthogonal to the direction of relative rotation; and
a device for biasing the flat surface towards the frusto-conical surface to maintain a gap between the surfaces within a predetermined dimensional range,
wherein the carrier comprises a plurality of portions releasably connected together.

2. Apparatus according to claim 1, where, in use, the carrier portions form a continuous sliding cylindrical surface that corresponds to a cylindrical surface on the first portion.

3. Apparatus according to claim 2, wherein a pair of said carrier portions are releasably connected together along a notional radial line extending from a centre of the cylinder.

4. Apparatus according to claim 1, wherein the carrier portions are connected together by a bolt arrangement.

5. Apparatus according to claim 1, wherein the carrier portions are connected together by a bridge member that spans the carrier portions, a first part of the bridge member being releasably connected to one of the carrier members and another part of the bridge member being releasably connected to another one of the carrier members.

6. Apparatus according to claim 5, wherein surfaces of the bridge member and corresponding surfaces of the carrier portions include cooperating formations.

7. Apparatus according to claim 6, wherein the bridge member is connected to each of the carrier portions by respective bolt arrangements and where, in use, tightening of the bolt arrangements reinforces engagement of the cooperating formations on the bridge member surfaces and the carrier portion surfaces.

8. Apparatus according to claim 1, wherein the carrier portions include inter-engaging formations.

9. Apparatus according to claim 8, wherein the inter-engaging formation on one of the carrier portions includes a step and the inter-engaging formation on the other said carrier portion includes a corresponding recess.

10. Apparatus according to claim 8, wherein the inter-engaging formations comprise dowels.

11. Apparatus according to claim 2, including a withdrawal space for allowing the carrier and a rotating member to be moved axially by a sufficient distance in order to disengage the cylindrical sealing surface during an access operation.

12. An axially moveable tile carrier defining a radial sealing surface for forming, with a further radial sealing surface, a radial seal to separate internal and external pressure areas and an axially sealing surface cooperating with an axially slidable seal to separate the internal and external pressure areas whereby the radial location of the seal is selected such that the pressure applied by the internal and external pressure areas to the radial sealing surface is substantially balanced by at least the internal and external pressures applied to respective pressure-balancing surfaces opposing the radial sealing surface and wherein the carrier comprises a plurality of portions releasably connected together.
